(19) United States
(12) Patent Application Publication
(10) Pub. No.: US 2015/0175293 A1
(43) Pub. Date: Jun. 25, 2015

(54) BOX MADE OF A CARDBOARD SHEET MATERIAL, BLANK OR BLANK ASSEMBLY, AND METHOD AND DEVICE FOR FORMING SUCH A BOX

(71) Applicants: Sebastien Jacomelli, Laives (FR); Pascal Monin, Dijon (FR)

(72) Inventors: Sebastien Jacomelli, Laives (FR); Pascal Monin, Dijon (FR)

(73) Assignee: OTOR, Puteaux (FR)

(21) Appl. No.: 14/409,744

(22) PCT Filed: Jun. 17, 2013
(86) PCT No.: PCT/FR2013/051412

§ 371 Date: Dec. 19, 2014

(30) Foreign Application Priority Data
Jun. 20, 2012 (FR) 12/01748

(51) Int. Cl. B65D 5/32; B31B 1/28; B31B 1/62; B65D 5/02

(52) U.S. Cl. CPC B65D 5/32; B65D 5/02; B31B 1/28; B31B 1/62

(57) ABSTRACT

The present invention relates to a box, to a blank or blank assembly, and to a method and device for forming a box made of a corrugated cardboard sheet material having a strap comprising at least four main rectangular panels, provided with at least one series of flaps suitable for at least partially forming the bottom and/or the tip of box, at least two of said main side panels being connected to a main central panel via intermediate panels forming cut corners without flaps. At least tow of the cut corners are formed by at least two rectangular cut side portions which are connected together or to the adjacent main panel by folding line, said cut side portions having a width of between 3 mm and 20 mm.

The present invention relates to a box of corrugated cardboard sheet material which has a polygonal cross-section, comprising a belt which comprises at least four main rectangular panels and which is provided with at least one series of flaps which are capable of at least partially forming the base and/or the top of the box, at least two of the main lateral panels being connected to a main central panel by intermediate panels, forming cut corners which do not have flaps.

The invention also relates to a blank or a set of blanks and a method and a device which allow such a box to be obtained.

A particularly important, though non-exclusive, use involves the field of boxes which are formed around a mandrel and which are provided to contain cylindrical products, for example, bottles.

There are already known boxes which are configured in order to optimize the internal volume available for containing rounded products.

For example, there are boxes having eight sides, that is, four main faces and four intermediate faces which have smaller dimensions and which allow better conformity to the shape of the products which are located inside the box.

Though such packagings have better resistance to compression and are readily able to be produced around mandrels, they do not allow optimization of the shape of the cut faces which remain with large dimensions, owing to the need for a specific distance which must exist between two grooves (also referred to below as scoring) and/or vertical folding lines.

There are also known, in particular in the context of packagings known as “wrap” packagings, corrugated cardboard sheets which are relatively flexible and which have rounded angles.

However, those packagings have poor resistance to compression and are difficult to form.

An object of the present invention is to provide a box of cardboard sheet material which has a polygonal cross-section and which better complies with the requirements of practice than previously known boxes, in particular in that it allows the disadvantages of known boxes to be overcome, by better resisting compression, and in that it will allow automatic packaging formation whose angles will be similar to a quarter of a circle without for all that being completely rounded, in an easy, automatic and efficient manner.

In so doing, it will be possible to combine the advantages of a box which can be produced in a rapid and repetitive manner with regard to the qualities which it has, and which has good resistance to compression. Advantageously, the walls and/or the corners have even better resistance to pressure, in particular as a result of the fact of their nature involving rigid tongues over a specific height, whilst being combined with walls and/or corners which also have specific heights, allowing a packaging having a shape which is as similar as possible to that of the products which it may contain, in particular when cylindrical products which are oval and/or round are involved, such as bottles.

To that end, the invention substantially proposes a box of corrugated cardboard sheet material which has a polygonal cross-section, the box comprising a belt which comprises at least four main rectangular panels and which is provided with at least one series of flaps which are capable of at least partially forming the base and/or the top of the box, at least two of the main lateral panels being connected to a main central panel by intermediate panels, forming cut corners which do not have flaps,

characterized in that at least two cut corners are formed by at least two rectangular portions of cut face which are connected to each other or to the adjacent main panel by a folding line, the portions of cut face having a width between 3 mm and 20 mm, and in that at least two opposing main panels have different widths.

The folding of those packagings may thus be brought about by wrapping around a mandrel, at least two opposing main panels having different widths which allows stacking of the dimensions and formation of the corners.

The construction of such multi-faceted boxes which therefore comprise rectangular cut faces which are located at distances close to each other allows preservation of a resistance to compression of the box with acceptable values, whilst allowing, as a result of the multiple facets thereof, which may be of different numbers, for example, from two to nine facets, a possibility of packagings which are completely adaptable to the products involved.

The cut corner(s) of the box therefore comprise up to ten simple, close-set scores or folding lines.

To that end, and in order to allow, in an automatic manner, the folding of those scores which are close together, it has been necessary to configure tools which allow them to be formed without crushing the score alongside (located a short distance away). This is done particularly as a result of foaming (coating with a layer of foam, for example, of plastics material) of the blades for forming the score which is provided so as not to crush the portions alongside (frustoconical form), or, in the event that the scores are too close together, by dispensing with any foaming and by perforating the scores in order to subsequently allow correct folding, which is otherwise impossible to obtain.

In advantageous embodiments, use is further and/or also made of one and/or other of the following arrangements:
the width of the portion of cut face is less than or equal to 10 mm, for example, less than 8 mm or 5 mm;
each main panel is connected to the adjacent main panels thereof by a cut corner;
at least two cut corners are each formed by at least three rectangular portions of cut face which have the same height and which are connected to each other by parallel folding lines, respectively;
at least two cut corners are each formed by at least four rectangular portions of cut face which have the same height and which are connected to each other by folding lines, respectively;
at least two cut corners are formed by at least eight rectangular portions of cut face which are connected to each other by folding lines;
two of the first opposing main panels have a first predetermined height and the other two second opposing main panels have a second predetermined height, the first height being different from the second height. The difference is, for example, less than two thicknesses of corrugated cardboard, for example, a thickness or a half-thickness. For a corrugated cardboard with micro-flutes less than 2 mm thick (category E in the applicable international classification), the three heights may be identical. On the other hand, for a more conventional flute of type B (3 mm thick) or C (4 mm thick), different heights may be provided for.

Such differences will allow different behavior of the box when it is compressed, allowing optimization and/or control of the consideration of the weights and pressures applied to the box in a progressive manner:
the cut corners have a third predetermined height which is different from the second height and/or the first height. Here again, the difference is, for example, less than two thicknesses or a thickness of corrugated cardboard, the cut faces advantageously having a smaller height than the adjacent panels;
at least two portions of cut face of the same cut corner have different widths. For example, a cut face has a width which is double or triple that of the adjacent cut face;
the box is formed from at least one blank comprising a succession of at least four main panels, each of which is connected to the adjacent panels thereof via intermediate panels forming cut corners, each main panel being provided with at least one flap, each cut corner comprising at least two portions of cut face;
each main panel is provided with a lower flap and an upper flap, the upper flaps being capable of forming the cover of the box, the lower flaps being capable of forming the base of the box;
the box is formed from two of the blanks which are wrapped around and bonded to each other in a head to tail arrangement;
the corrugated cardboard has micro-flutes (thickness <2 mm).

The invention also proposes a blank or set of blanks for forming a box as described above.

It also proposes a blank or set of blanks which is produced from corrugated cardboard sheet material and which is intended to form a box of polygonal cross-section, the blank or each of the blanks comprising a belt which comprises at least four main rectangular panels and which is provided with at least one series of flaps which are capable of at least partially forming the base and/or the top of the box, at least two of the main lateral panels being connected to a main central panel by intermediate panels, forming cut corners which do not have flaps,

characterized in that, each intermediate panel being formed by at least two rectangular portions of cut face which are connected to each other or the adjacent main panel by a folding line, the portions of cut face have widths between 3 mm and 20 mm.

Advantageously, the width is less than or equal to 10 mm or 5 mm.

In other advantageous embodiments, use is further made of one and/or other of the following provisions:
each main panel is connected to the adjacent main panels thereof by intermediate panels;
at least two cut corners are formed by at least three rectangular portions of cut face which have the same length and which are connected to each other by parallel folding lines;
at least two cut corners are formed by at least four rectangular portions of cut face which have the same length and which are connected to each other by first folding lines;
at least two cut corners are formed by at least eight rectangular portions of cut face which are connected to each other by folding lines;
two of the first opposing main panels have a first predetermined length and the other two second opposing main panels have a second predetermined length, the first length being different from the second length, for example, by a thickness of corrugated cardboard;
the cut corners have a third predetermined length which is different from the second length and/or the first length.

The invention also proposes a device for forming a box as described above.

It also proposes a device for forming a box from at least one blank of corrugated cardboard sheet comprising a belt which comprises at least four main rectangular panels and which is provided with at least one side having a series of flaps which are capable of at least partially forming the base of the box, characterized in that,

with at least two main panels being connected to a main central panel by intermediate panels forming cut corners which do not have flaps, each cut corner being formed by at least two rectangular portions of cut face which are connected to each other by folding lines, it comprises
an assembly for picking the blank, means for gluing the blank during the transfer to a mandrel,
the mandrel comprising at least two edges which comprise rounded angles capable of cooperating with the cut corners,
means for wrapping the blank around the mandrel in order to form the belt of the box and
pressing means which are configured in order to fold the cut corners on the rounded edges and the flaps around the mandrel in order to form the base of the box by adhesive bonding.

The invention also proposes a method for forming a box from at least one blank of corrugated cardboard sheet, comprising a belt which comprises at least four main rectangular panels and which is provided with at least one side having a series of flaps which are capable of at least partially forming the base of the box, characterized in that,

with at least two main panels being connected to a main central panel by intermediate panels forming cut corners which do not have flaps, each cut corner being formed by at least two intermediate panels which form rectangular portions of cut face which are connected to each other by folding lines,
after the blank has been picked,
the blank is glued during its transfer towards a mandrel which comprises at least two edges which comprise rounded angles which are capable of cooperating with the cut corners,
the blank is wrapped around the mandrel in order to form the belt of the box and
the intermediate panels are pressed on the rounded edges and the flaps are pressed around the mandrel in order to form the cut corners and the base of the box by adhesive bonding.

Advantageously, the box is formed from two blanks, the second blank being wrapped on the first blank once formed, and/or being glued beforehand to the first before forming in a manner known per se.

The invention will be better understood from a reading of the embodiments given below by way of non-limiting example. It refers to the drawings which accompany it and in which:

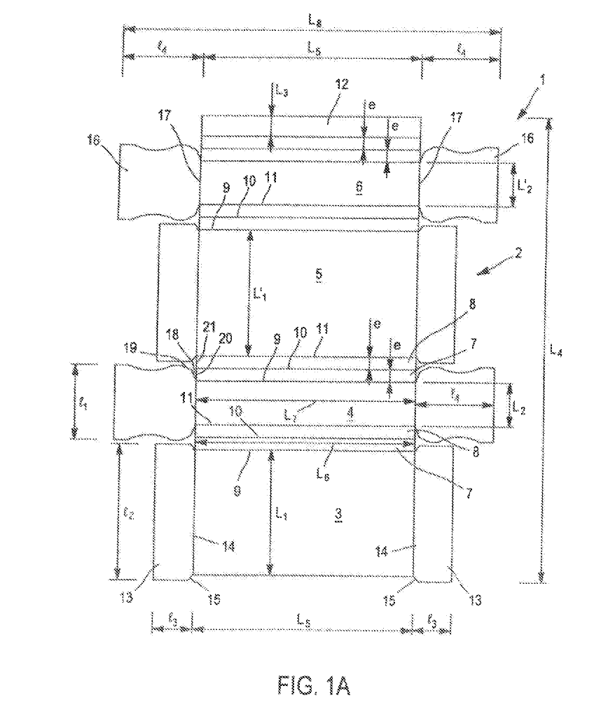

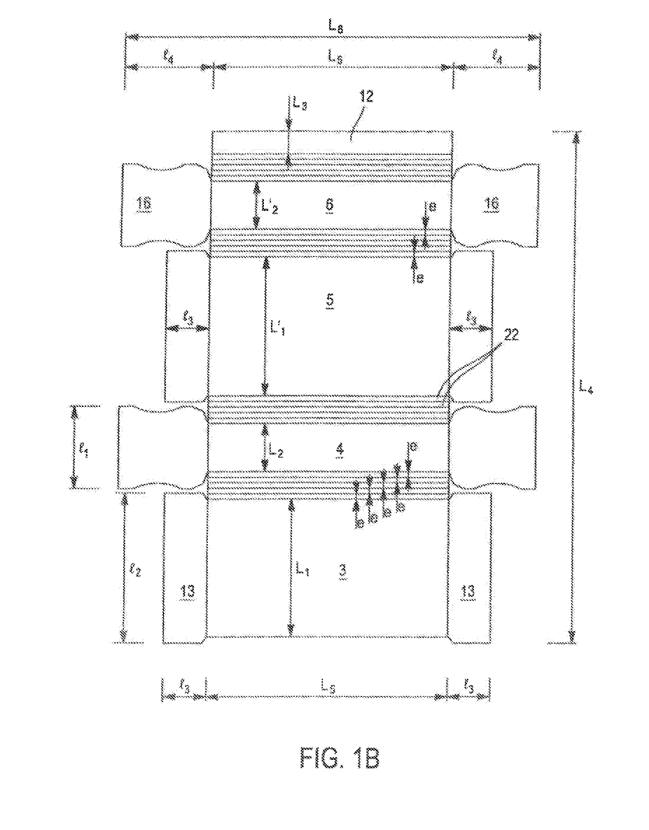

FIG. 1A is a top view of a blank according to a first embodiment of the invention.

FIG. 1B is a top view of a blank according to a second embodiment of the invention.

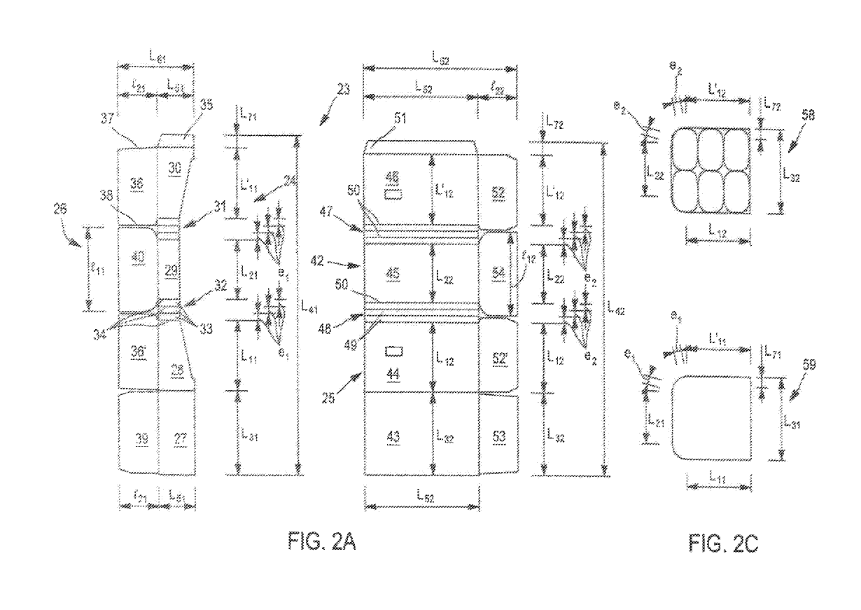

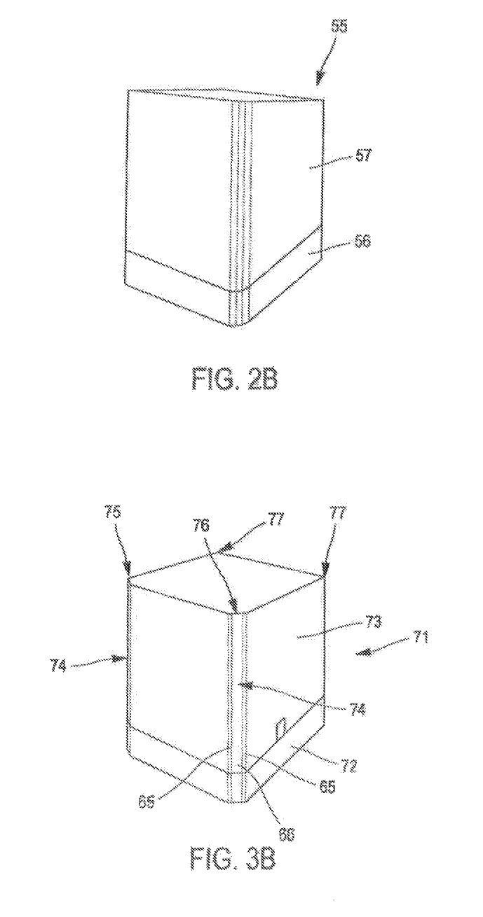

FIG. 2A is a top view of a set of blanks according to a third embodiment of the invention.

FIG. 2B is a perspective view of the box formed from the blanks of FIG. 2A.

FIG. 2C are cross-sections at two different regions of a box obtained with the set of blanks of FIG. 2B.

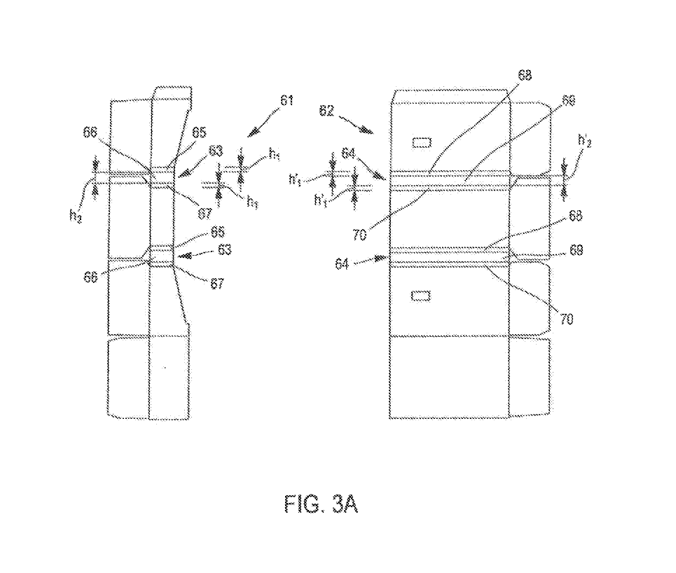

FIG. 3A is a top view of a set of blanks according to a fourth embodiment of the invention.

FIG. 3B is a perspective view of the box obtained with the set of blanks of FIG. 3A.

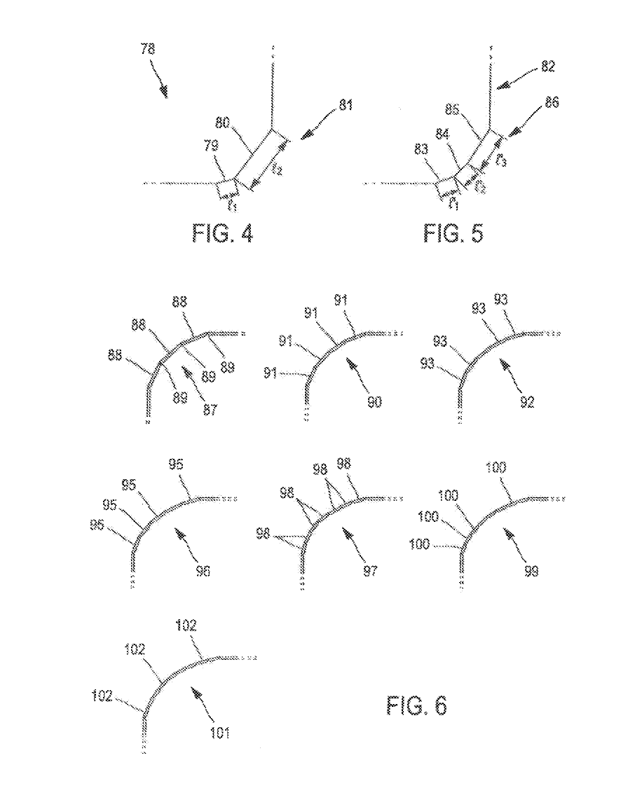

FIGS. 4 and 5 are cross-sections schematically showing two embodiments of cut corners according to the invention.

FIG. 6 is a cross-section of a plurality of embodiments of faces of cut corners (from three to nine) according to the invention.

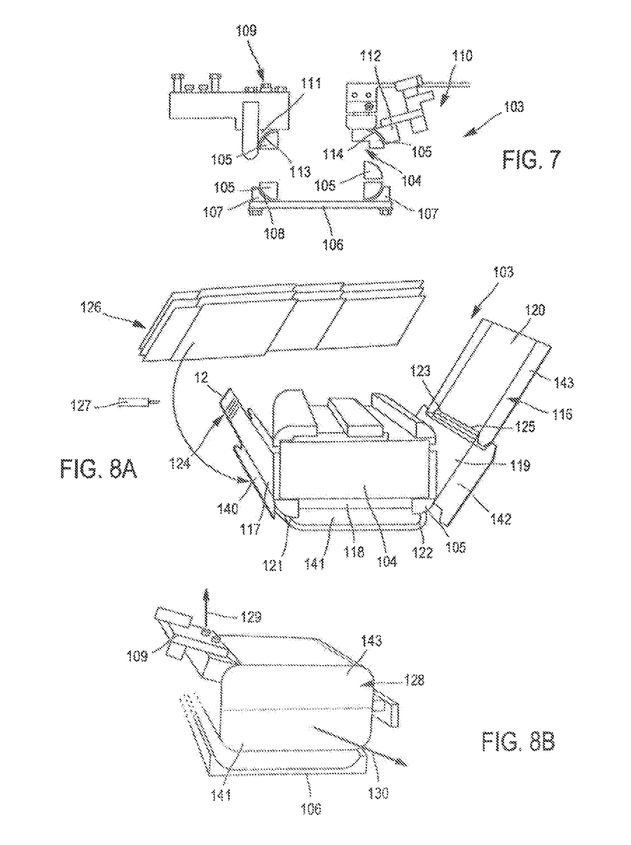

FIG. 7 is a schematic front view of a portion of the device for forming a box according to an embodiment of the invention.

FIGS. 8A and 8B are perspective views of the device of FIG. 7, showing two forming steps according to the invention during the wrapping and before the discharge.

FIG. 1A shows a blank 1 which comprises a belt 2 of four main rectangular panels 3, 4, 5, 6, that is to say, two first main panels 3, 5 having a width L₁ and L′₁, respectively, and two second main panels 4 and 6 having a width L₂, L′₂, respectively.

Each of the panels 3, 4, 5, 6 is connected to the adjacent panels by two portions 7, 8 having a rectangular cut face having a width e via three parallel folding lines 9, 10, 11.

The folding lines are formed by means of a flat blank machine, for example, a machine manufactured by the Swiss company BOBST, so that the adjacent folding lines are not crushed during production of the blank.

To that end and in the event that the width e is greater than 15 mm (up to 20 mm), the accompanying foam which surrounds the blade for marking the groove has dimensions not exceeding 12 mm at one side and the other of the blade.

If the dimension is smaller, the length of the foam is also reduced and perforations (not illustrated), for example, having a length less than 1 cm, are produced every 1 cm or less, for example, perforations having a length of 3 mm spaced apart from each other by 3 mm.

That allows minimization of the pressure for forming the groove whilst subsequently allowing folding which is easy and adequate.

The belt is further terminated with a bonding tongue 12 having a length L₃.

Each of the panels 3 and 5 terminates at one side and the other with a rectangular flap 13 which has lower corners 15 at the side of the junction line 14 with respect to the panel, at an angle of 45° relative to the folding line.

The flaps have a length l₂ and a width l₃.

Each of the panels 4 and 6 itself comprises a flap 16 which is connected to the panel by folding lines 17, the flaps having a tulip-like shape and a width l₁ and a height l₄, so that, when the box is closed, the base and the top of the box coincide substantially with respect to the open top of the box, the corner of the tulip-like member at the side of the line 17 having facets 18, 19 and being capable of cooperating and/or coinciding with the end 20, 21 of the portions of cut faces 7 and 8.

The panels and portions of cut faces further have for the panels 3, 5 heights or a length L₅, the panels 4, 6 a length L₇ and the cut faces 7, 8 a length L₆.

In the embodiment described with reference to FIG. 1A, the dimensions are (in a manner by no means limiting), for example, as follows, for a corrugated cardboard of category E (micro-flute thickness <2 mm).

| | |
|---|---|
| L₁ = 150 mm | e = 15 mm |
| L′₁ = 151 mm | l₁ = 88 mm |
| L₂ = 51 mm | l₂ = 100 mm |
| L′₂ = 50 mm | l₃ = 44 mm |
| L₃ = 25 mm | l₄ = 92 mm |
| L₄ = 554 mm | |
| L₅ = L₆ = L₇ = 248 mm | |
| L₈ = 432 mm | |

### Where:

L₁ and L₅ are the width and length of the panel 3,
L₂ and L₇ are the width and length of the panel 4,
L′₁ and L₅ are the width and length of the panel 5,
L′₂ and L₇ are the width and length of the panel 6,
L₃ is the width of the tongue l₂, L₄ is the total length of the blank and L₈ is the total width,
e is the width of the portions of cut face, L₆ is the length of the faces,
l₁ and l₄ are the length and width of the flaps 16 and
l₂ and l₃ are the length and width of the flaps 13.

In the remainder of the description, the same reference numerals will be used to designate the same elements or similar elements.

FIG. 1B shows another embodiment which also has micro-flutes, the portions of cut faces 22 in this instance being five in number and being less wide, for example, e=7 mm.

The other values are, for example:

| | |
|---|---|
| L₁ = 146 mm | e = 7 mm |
| L₂ = 44 mm | l₁ = 88 mm |
| L′₂ = 43 mm | l₂ = 100 mm |
| L₃ = 25 mm | l₃ = 44 mm |
| L₄ = 552 mm | l₄ = 92 mm |
| L₅ = L₆ = L₇ = 248 mm | |
| L₈ = 432 mm | |

Advantageously, therefore:

L₁=L′₁ or L₁<L′₁, for example, from 1 to 2 mm.
L₂=L′₂ or L₂<L′₂, for example, from 1 to 2 mm.

It is also possible to have L₅≠L₆, for example, L₅=248 mm, L₇=246 mm and L₆=L₇ or L₆≠L₇=245 mm.

FIG. 2A illustrates another embodiment of a set 23 of blanks 24 and 25 according to the invention.

The blank 24 is capable of forming a lower tray. It comprises a belt 26 which is provided with four main panels 27, 28, 29, 30, the central rectangular panel 29 being separated from the two adjacent trapezium-like panels 28, 30 thereof by two cut corners 31, 32, each cut corner being formed by three portions of identical rectangular faces 33 which are connected to each other and to the adjacent panel by folding lines 34. A rectangular panel 27 having a side and a rectangular bonding tongue 35 are also provided.

Each main panel 28, 30 terminates at one side with a flap 36, 36′, which flaps are symmetrical to each other in relation to a transverse center axis of the panel 29, and comprise a side 37 which is substantially rectilinear, and the other side 38 having a cut corner which has an angle less than 45°.

The panel 27 comprises a substantially rectangular flap 39 and the panel 29 comprises a panel 40 with a lower corner cut at the side of the junction line 41 with respect to the panel 29, in order to cooperate with the end of the faces 33 during the formation of the box.

The blank 25 is capable of forming the cover of the box. It itself comprises, in a parallel manner, a belt 42 which is provided with four main panels 43, 44, 45, 46, the rectangular central panel 45 being separated from the two adjacent panels 44, 46 thereof, which are also rectangular, by two cut corners 47, 48 formed by three identical rectangular face portions 49 which are connected to each other and/or to the adjacent panels by folding lines 50.

The rectangular panel 43 and a bonding tongue 51 are provided at one side and the other of the succession of panels.

In a manner identical to the first blank 24, flaps 52, 52′, 53 and 54 which are symmetrical, in relation to the direction of the blank, with the flaps 36, 36′, 39 and 40, are provided.

FIG. 2B is a perspective view of a box 55 which is produced from blanks 24 and 25 of FIG. 2A, comprising the tray 56 and the cover 57.

FIG. 2C is a cross-section of the box in the region 58 of the cover of the box and in the region 59 of the base of the box.

By way of example, the values of the dimensions are as follows (in mm): (cf. FIGS. 2A and 2C)

| | |
|---|---|
| L₁₁ = 163 | l₁₁ = 190 |
| L′₁₁ = 164 | l₂₁ = 94 |
| L₂₁ = 135 | e₁ = 16 |
| L₃₁ = 195 | l₁₂ = 190 |
| L₄₁ = 778 | l₂₂ = 93 |
| L₅₁ = 82 | e₂ = 15 |
| L₆₁ = 176 | L₅₂ = 276 |
| L₇₁ = 25 | L₆₂ = 369 |
| L₁₂ = 161 | L₇₂ = 30 |
| L′₁₂ = 159 | |
| L₂₂ = 134 | |
| L₃₂ = 193 | |
| L₄₂ = 767 | |

### Where:

L₁₁, L′₁₁, L₂₁, L₃₁ are the lengths of the panels 28, 30, 29, 27,
L₄₁ is the total length of the blank 23, L₆₁ is the total width of the blank,
L₅₁ is the height (or width) of the panel 27, L₇₁ is the width of the tongue 35, l₁₁ and l₂₁ are the length and width of the flap 40, e₁ is the width of the portion of cut face 33.

The references indexed “2” (for L₁₂, L′₁₂, etc.) correspond to the dimensions of the panels and/or flaps of the blank 25 corresponding to those of the blank 24.

FIG. 3A shows another embodiment of the invention of the type described with reference to FIGS. 2A to 2C.

In this instance, the blanks 61 and 62 comprise cut corners 63, 64 which are each provided with three portions of faces 65, 66, 67 and 68, 69, 70, that is to say, two portions 65, 67 having a first width h₁ separated by a portion 66 having a second width h₂ and two portions 68 and 70 having a first width h′₁ separated by a portion 69 having a second width h′₂, where, for example, h₁=7 mm, h₂=21 mm and h′₁=6 mm and h′₂=20 mm.

FIG. 3B is a perspective view of the box 71 obtained with the blanks of FIG. 3A, that is to say, the blank 61 for making the tray 72 and the blank 62 for making the cover 73 with the cut face 74 having three facets at the two sides 75 and 76, the other corners 77 of the box not having any facets.

FIGS. 4 and 5 show two embodiments of cut corners of a box according to the invention.

FIG. 4 shows a box angle 78 which is provided with two portions 79 and 80 of cut face, forming the cut corner 81, the portion 79 having a first width l₁, for example, between 3 mm and 8 mm, for example, 5 mm, and the second portion 80 of cut face having a width l₂ which is greater than the width e₁, for example, between 10 mm and 20 mm, for example, 15 mm.

FIG. 5 shows a second embodiment of a box angle 82, this time provided with three portions 83, 84, 85 of cut face having three different widths in order to form the cut corner 86, the portion 83 of cut face having a first width l′₁, for example, between 2 mm and 5 mm, for example, 3 mm, the second portion 84 of cut face having a width 1′₂, for example, of 5 mm, and the third portion 85 of cut face having a width 1′₃, for example, between 12 and 20 mm, for example, 17 mm.

FIG. 6 illustrates other examples of cut corners, having facets, which can be used with the box according to the invention.

FIG. 6 specifically shows a first embodiment of a cut corner 87 which is provided with three identical rectangular portions 88 of cut face, which are separated from each other, and with respect to the adjacent panels, by vertical folding lines 89 of the same height.

Other embodiments of cut corners are also illustrated here, that is to say:

A cut corner 90, with four identical vertical portions of cut face, a corner 92 with five identical portions 93 of cut face, a corner 94 with six identical portions 95 of cut face, a corner 97 with seven portions 98 of cut face, a corner 99 with eight portions 100 of cut face and a corner 101 with nine rectangular portions 102 of cut face having the same height, which portions are therefore all separated by folding lines or scores which are provided to allow the folding thereof.

Thus, from more than four to five cut faces, taking into account the general dimensions of the boxes and so as to allow optimized folding thereof, the grooves or scores or folding lines will be, for example, precut over short distances, over the entire length of the folding line, in order to facilitate folding thereof.

FIG. 7 shows schematically and in a partial manner a forming device 103 for a box (not illustrated) in accordance with one of the embodiments described above.

That device comprises in particular and more specifically a mandrel 104, for example, constituted by rounded angles 105 at the four corners of the mandrel around which the box will therefore be able to be formed.

Those rounded angles are rounded at 45°.

They are formed by tubular elements which are also illustrated more clearly in FIGS. 8A and 8B.

Those tubular elements, for example, in the form of an angle member, have an outer cylindrical surface, around which the folding of the cut corners of the box according to the invention will be able to be brought about.

To that end, the blank which is, for example, brought below the mandrel, is pressed by means of a pushing plate 106 comprising angle members 107 which are configured to cooperate, and are therefore of a complementary shape, with the rounded external edges 108 of the angle members of the mandrel 104.

Pushing/pressing means 109 and 110 located on the upper portion of the mandrel are further also provided in order to operate in a manner known per se.

Those pushing/pressing means 109 and 110 comprise in a similar manner angle pieces 111, 112 which are provided with an external surface 113, 114 in the form of a cylindrical portion for cooperation with the external cylindrical face 108 (in the form of a quarter-cylinder portion) of the angle members 105 of the mandrel 104.

FIGS. 8A and 8B illustrate other elements which allow a better understanding of the operation of the device according to the invention and therefore of the forming method described in greater detail.

The device 103 is configured in order to form, from the blank 116 of corrugated cardboard sheet, for example, with micro-flutes, comprising a belt which comprises at least four main rectangular panels 117, 118, 119, 120 which are separated by the cut corners 121, 122, 123, 124 as described above, the cut corners therefore being formed by portions of cut faces which are connected to each other by folding lines 125.

The device 103 comprises a blank picking assembly 126 which is indicated in the Figure, gluing means 127 for gluing in a manner known per se at the locations desired on the tongues and/or the flaps, for example, using glue known as “hot melt” glue which is injected under high pressure.

As seen, the mandrel 104 comprises the edges 105 which comprise rounded angles 108 which are therefore capable of cooperating with the cut corners 121, 122, 123, 124.

The wrapping means mentioned above will wrap the blanks around the mandrel and allow the formation of the belt of the box, the pressing means 106, 109 and 110 subsequently folding the cut corners at the rounded edges and the flaps around the mandrel.

Taking into account the folding lines which are clearly marked and optionally thereby assisted by the precut portions of a portion of those folding lines, the folds will be carried out so as to correctly take up the occurrences of play when the box is formed around the mandrel.

That is allowed as a result of the guiding action which is brought about both by the pushing plate 106 which allows self-centering of the central panel of the blank (previously positioned in a very precise manner on the lower edges) and by the pieces 109 and 110 which will themselves be able to assist in forming folds, in an extremely easy manner, further taking into account the obstructions of the remainder of the panel.

FIG. 8B shows the box 128 which is obtained after removal of the pushing plate 106 just before the cut corners are discharged.

The pieces 109 and 110 are subsequently moved away upward (arrow 129), allowing the release of the box which is, for example, pushed back in a manner known per se by means of actuators which are located inside the box which is then discharged in the direction of the arrow 130.

The operation of the device for forming a box according to the invention will now be described in greater detail with reference to FIGS. 1A, 8A and 8B.

On the basis of a blank of corrugated cardboard sheet, in particular and more specifically with micro-flutes, which involves a given fragility of the material and a given difficulty in folding it, that blank is picked by conventional techniques for taking blanks (located in the vertical or in an inclined plane) by means of a suction cup system.

The packaging is then displaced below the mandrel via, for example, a conveyor belt (not illustrated).

With the blank being positioned precisely under the mandrel, it is subsequently raised and pre-pressed by means of the pushing plate 106, in such a manner that the cut corners move into alignment with the lateral angle members 105 of the mandrel.

The pushing plate is subsequently advanced and the blank takes up a position, the cut corners bending in accordance with the pressurization, the lateral panels 119 and 117 themselves being maintained laterally in order to allow adequate folding, without for all that the cut corners and the portions of cut faces thereof being completely crushed against the angle members 105, which would have the effect of making the cut corner completely rounded without benefiting from the facet-like appearance thereof as indicated above.

The remaining portions of the blank are subsequently wrapped around the mandrel in a progressive manner until the cut corners 123, 124 move into contact with the angle members 105 from above the mandrel, then a pressing system allows formation of the cut corners on the rounded edges of the mandrel, as for the lower cut corners, thereby allowing the close-set folds of the facets which are formed by the portions of cut faces of the packaging.

Subsequently, the upper panel 120 is definitively closed, the positioning of the end tongue being carried out at the end of the panel 120 by pressing.

Subsequently and/or simultaneously, the flaps 140, 141, 142 and 143 which are intended to form the base of the box and which are of identical shape to the cross-section of the blanks once they have been folded, including the cut corners, are pressed against the end of the mandrel, the initial gluing by means of the gluing means 127 having in the meantime been carried out during the movement.

The box is subsequently discharged in accordance with the arrow 130 with reference to FIG. 8B.

As is self-evident and as further results from the above, the present invention is not limited to the embodiments which are described in greater detail. Instead, it includes all the variants and in particular those in which it comprises an access location with the blank on the mandrel from above and not from below, as described in greater detail.

1. A box (55, 71) of corrugated cardboard sheet material which has a polygonal cross-section, the box comprising a belt which comprises at least four main rectangular panels and which is provided with at least one series of flaps which are capable of at least partially forming the base and/or the top of the box, at least two of the main lateral panels being connected to a main central panel by intermediate panels, forming cut corners which do not have flaps, at least two cut corners being formed by at least two rectangular portions of cut face which are connected to each other or to the adjacent main panel by a folding line,
characterized in that the portions of cut face have a width between 3 mm and 20 mm and in that at least two opposing main panels have different widths.

2. The box as claimed in claim 1, characterized in that the width of the portion of cut face is less than or equal to 10 mm.

3. The box as claimed in claim 1, characterized in that each main panel is connected to the adjacent main panels thereof by a cut corner.

4. The box as claimed in claim 1, characterized in that at least two cut corners are each formed by at least three rectangular portions of cut face which have the same height and which are connected to each other by parallel folding lines, respectively.

5. The box as claimed in claim 4, characterized in that at least two cut corners are each formed by at least four rectangular portions of cut face which have the same height and which are connected to each other by folding lines, respectively.

6. The box as claimed in claim 5, characterized in that at least two cut corners are formed by at least eight rectangular portions of cut face which are connected to each other by folding lines.

7. The box as claimed in claim 1, characterized in that two of the first opposing main panels have a first predetermined height and the other two second opposing main panels have a second predetermined height, the first height being different from the second height.

8. The box as claimed in claim 1, characterized in that the cut corners have a third predetermined height which is different from the second height and/or the first height.

9. The box as claimed in claim 1, characterized in that at least two portions of cut face of the same cut corner have different widths.

10. The box as claimed in claim 1, characterized in that the box is formed from at least one blank comprising a succession of at least four main panels, each of which is connected to the adjacent panels thereof via intermediate panels forming cut corners, each main panel being provided with at least one flap, each cut corner comprising at least two portions of cut face.

11. The box as claimed in claim 1, characterized in that each main panel is provided with a lower flap and an upper flap, the upper flaps being capable of forming the cover of the box, the lower flaps being capable of forming the base of the box.

12. The box as claimed in claim 1, characterized in that the box is formed from two of the blanks which are wrapped around and bonded to each other in a head to tail arrangement.

13. A blank or set of two blanks which is produced from corrugated cardboard sheet material and which is intended to form a box of polygonal cross-section, the blank or each of the blanks comprising a belt which comprises at least four main rectangular panels and which is provided with at least one series of flaps which are capable of at least partially forming the base and/or the top of the box, at least two of the main lateral panels being connected to a main central panel by intermediate panels, forming cut corners which do not have flaps, each intermediate panel being formed by at least two rectangular portions of cut face which are connected to each other or the adjacent main panel by a folding line, characterized in that the portions of cut face have widths between 3 mm and 20 mm, and in that at least two opposing main panels have different widths.

14. The blank or set of blanks as claimed in claim 13, characterized in that the width of a portion of cut face is less than or equal to 10 mm.

15. The blank or set of blanks as claimed in claim 13, characterized in that each main panel is connected to the adjacent main panels thereof by intermediate panels.

16. The blank or set of blanks as claimed in claim 13, characterized in that at least two cut corners are formed by at least three rectangular portions of cut face which have the same length and which are connected to each other by parallel folding lines.

17. The blank or set of blanks as claimed in claim 16, characterized in that at least two cut corners are formed by at least four rectangular portions of cut face which have the same length and which are connected to each other by folding lines.

18. The blank or set of blanks as claimed in claim 17, characterized in that at least two cut corners are formed by at least eight rectangular portions of cut face which are connected to each other by folding lines.

19. The blank or set of blanks as claimed in claim 13, characterized in that two of the first opposing main panels have a first predetermined length and the other two second opposing main panels have a second predetermined length, the first length being different from the second length.

20. The blank or set of blanks as claimed in claim 13, characterized in that the cut corners have a third predetermined length which is different from the second length and/or the first length.

21. The blank or set of blanks as claimed in claim 13, characterized in that at least two portions of cut face of the same intermediate panels forming a cut corner have different widths.

22. A device for forming a box from at least one blank of corrugated cardboard sheet, comprising a belt which comprises at least four main rectangular panels and which is provided with at least one side having a series of flaps which are capable of at least partially forming the base of the box,
with at least two main panels being connected to a main central panel by intermediate panels forming cut corners which do not have flaps, each cut corner being formed by at least two rectangular portions of cut face which are connected to each other by folding lines, the device comprising an assembly for picking the blank,
characterized in that, the portions of cut face having a width between 3 mm and 20 mm and at least two opposing main panels having different widths, the device comprises means for gluing the blank during the transfer to a mandrel,
the mandrel comprising at least two edges which comprise rounded angles capable of cooperating with the cut corners,
means for wrapping the blank around the mandrel in order to form the belt of the box and pressing means which are configured in order to fold the cut corners on the rounded edges and the flaps around the mandrel in order to form the base of the box by adhesive bonding.

23. A method for forming a box from at least one blank of corrugated cardboard sheet, comprising a belt which comprises at least four main rectangular panels and which is provided with at least one side having a series of flaps which are capable of at least partially forming the base of the box,
characterized in that,
with at least two main panels being connected to a main central panel by intermediate panels forming cut corners which do not have flaps, each cut corner being formed by at least two intermediate panels which form rectangular portions of cut face which are connected to each other by folding lines, characterized in that, the portions of cut face having a width between 3 mm and 20 mm, and at least two opposing main panels having different widths,
after the blank has been picked,
the blank is glued during the transfer towards a mandrel,
the mandrel comprising at least two edges which comprise rounded angles which are capable of cooperating with the cut corners,
the blank is wrapped around the mandrel in order to form the belt of the box and
the intermediate panels are pressed on the rounded edges and the flaps are pressed around the mandrel in order to form the cut corners and the base of the box.

24. The method for forming a box as claimed in claim 23, characterized in that the box is formed from two blanks, the second blank being wrapped on the first blank once the first blank is formed.
